(19) United States
(12) Patent Application Publication
(10) Pub. No.: US 2022/0303261 A1
(43) Pub. Date: Sep. 22, 2022

(54) METHODS AND APPARATUS FOR LIGHTWEIGHT MACHINE TO MACHINE COMMUNICATION

(71) Applicant: Telefonaktiebolaget LM Ericsson (publ), Stockholm (SE)

(72) Inventors: Gonzalo CAMARILLO GONZALEZ, Helsinki (FI); Mert OCAK, Helsinki (FI); Ari KERÄNEN, Helsinki (FI)

(21) Appl. No.: 17/616,768

(22) PCT Filed: Jun. 15, 2019
(86) PCT No.: PCT/EP2019/065788

§ 371 Date: Dec. 6, 2021

(51) Int. Cl. H04L 9/40; H04L 65/1073; H04L 67/12; H04W 4/70

(52) U.S. Cl. CPC H04L 63/0807; H04L 63/0823; H04L 65/1073; H04L 67/12; H04W 4/70

(57) ABSTRACT

A method for operating a system comprising a LwM2M client node, a LwM2M master client node and a LwM2M management server. The method includes the LwM2M master client node sending to the LwM2M management server a request to register the LwM2M client node, the LwM2M management server confirming registration of the LwM2M client node to the LwM2M master client node, and the LwM2M management server and LwM2M client node exchanging application messages. Also disclosed are a LwM2M master client node, LwM2M server and LwM2M client node, and methods of operation of a LwM2M master client node, LwM2M server and LwM2M client node.

### TECHNICAL FIELD

The present disclosure relates to methods performed by a Lightweight Machine to Machine (LwM2M) server, LwM2M client node and LwM2M master client node. The present disclosure also relates to a LwM2M server, LwM2M client node and LwM2M master client node, and to a computer program and a computer program product configured, when run on a computer to carry out methods performed by a LwM2M server, LwM2M client node and LwM2M master client node.

### BACKGROUND

The “Internet of Things” (IoT) refers to devices enabled for communication network connectivity, so that these devices may be remotely managed, and data collected or required by the devices may be exchanged between individual devices and between devices and application servers. Such devices, examples of which may include sensors and actuators, are often, although not necessarily, subject to severe limitations on processing power, storage capacity, energy supply, device complexity and/or network connectivity, imposed by their operating environment or situation, and may consequently be referred to as constrained devices. Constrained devices often connect to the core network via gateways using short range radio technologies. Information collected from the constrained devices may then be used to create value in cloud environments.

The constrained nature of IoT devices has prompted the design and implementation of new protocols and mechanisms. The Constrained Application Protocol (CoAP), as defined in RFC 7252, is one example of a protocol designed for IoT applications in constrained nodes and constrained networks. CoAP provides a request-response based RESTful communication architecture between constrained nodes or between constrained nodes and nodes on the Internet. CoAP can easily be integrated to the web and web services by translating CoAP messages to HTTP. Another example of a protocol suited to IoT applications is the Message Queueing Telemetry Transport (MQTT) protocol. MQTT is a lightweight, open source publish/subscribe messaging transport protocol designed for power constrained devices and low-bandwidth, high-latency networks.

The Open Mobile Alliance (OMA) Lightweight Device Management (DM) protocol, also known as the Lightweight Machine to Machine protocol (LwM2M), is a light and compact device management protocol that may be used for managing IoT devices and their resources. LwM2M is designed to run on top of CoAP, and LwM2M is therefore compatible with any constrained device which supports CoAP. In addition, work is ongoing to standardize an MQTT transport solution for LwM2M. LwM2M defines three components:
LwM2M Client: contains several LwM2M objects with resources. A LwM2M Management Server can execute commands on the resources to manage the client, including reading, deleting or updating resources. LwM2M Clients are generally run in constrained devices.
LwM2M Management Server: manages LwM2M Clients by sending management commands to them.
LwM2M Bootstrap Server: is used to manage the initial configuration parameters of LwM2M Clients during bootstrapping of a device.

In order to maintain communication between the above discussed components, the following LwM2M interfaces are defined:
Bootstrapping: LwM2M Bootstrap Server sets the initial configuration on a LwM2M Client when the client device bootstraps.
Client Registration: LwM2M Client registers to one or more LwM2M Management Servers when bootstrapping is completed.
Device Management and Service Enablement: LwM2M Management Server can send management commands to LwM2M Clients to perform several management actions on LwM2M resources of the client. An access control object of the client determines the set of actions the server can perform.
Information Reporting: LwM2M Clients can initiate communication to a LwM2M Management Server and report information in the form of notifications.

A constrained device is configured during bootstrap for a specific environment and/or domain before being deployed to use that domain's LwM2M Management Server. During bootstrapping, a LwM2M Bootstrap Server updates client security information with the assigned LwM2M Management Server address and credentials for the LwM2M Client. In this manner, the assigned LwM2M Management Server is given management rights on the client.

CoAP, over which LwM2M runs, is designed for constrained devices and networks. However, when only a subset of the capabilities provided for in CoAP is required, a CoAP implementation can be simplified even further to only a few hundreds of bytes and close to zero RAM use. It is likely that such implementations would have to rely on network level security, as the implementation would not include Datagram Transport Layer Security (DTLS). For very constrained devices or networks in which such simplified implementations of CoAP are envisaged, supporting the full range of LwM2M interactions as set out above is not a viable option. In light of this, a gateway model has been suggested for upcoming versions of LwM2M. This model would enable very simple devices to connect to a LwM2M management server via a LwM2M gateway.

Although addressing some of the issues involved in implementing LwM2M in very constrained devices, a LwM2M gateway solution introduces a permanent network element that needs to be provisioned, operated, and maintained. In particular, the gateway needs to be in the network (IP) path between the devices and the LwM2M server(s). In addition, this gateway-based approach does not help with constrained networks if the gateway also needs to reside in the constrained network, and so is subject to similar constraints to those placed on the devices.

### SUMMARY

It is an aim of the present disclosure to provide methods, apparatus and computer readable media which at least partially address one or more of the challenges discussed above.

According to a first aspect of the present disclosure, there is provided a method for operating a system comprising a LwM2M client node, a LwM2M master client node and a LwM2M management server. The method comprises the LwM2M master client node sending to the LwM2M management server a request to register the LwM2M client node, the LwM2M management server confirming registration of the LwM2M client node to the LwM2M master client node, and the LwM2M management server and LwM2M client node exchanging application messages.

Examples of the present disclosure thus allow for a solution in which a LwM2M master client node can perform registration or another operation on behalf of a client node without remaining in the network path between the client and a LwM2M server. Once registration is complete, application messages, such as data reporting or notifications, can be exchanged between the client node and the LwM2M server without involving the LwM2M master client node.

According to examples of the present disclosure, the LwM2M client node comprises a physical or virtual node on which a LwM2M client is running. The LwM2M client node may be a constrained node and may be operable to connect to a constrained network. For the purposes of the present disclosure, a constrained device comprises a device which conforms to the definition set out in section 2.1 of RFC 7228 for “constrained node”. According to the definition in RFC 7228, a constrained device is a device in which “some of the characteristics that are otherwise pretty much taken for granted for Internet nodes at the time of writing are not attainable, often due to cost constraints and/or physical constraints on characteristics such as size, weight, and available power and energy. The tight limits on power, memory, and processing resources lead to hard upper bounds on state, code space, and processing cycles, making optimization of energy and network bandwidth usage a dominating consideration in all design requirements. Also, some layer-2 services such as full connectivity and broadcast/multicast may be lacking”. Constrained devices are thus clearly distinguished from server systems, desktop, laptop or tablet computers and powerful mobile devices such as smartphones. A constrained device may for example comprise a Machine Type Communication device, a battery powered device or any other device having the above discussed limitations. Examples of constrained devices may include sensors measuring temperature, humidity and gas content, for example within a room or while goods are transported and stored, motion sensors for controlling light bulbs, sensors measuring light that can be used to control shutters, heart rate monitor and other sensors for personal health (continuous monitoring of blood pressure etc.) actuators and connected electronic door locks.

According to examples of the present disclosure, the LwM2M server may be a virtualised function running in a cloud deployment, and the LwM2M master client node may be a physical node or virtual node.

According to another aspect of the present disclosure, there is provided a method performed by a LwM2M master client node. The method comprises sending a request message to a LwM2M server, the request message requesting the LwM2M server to perform an operation with respect to a LwM2M client node, and instructing the LwM2M server that, following completion of the operation, any subsequent messages relating to the LwM2M client node should be exchanged between the LwM2M client node and the LwM2M server. The subsequent messages relating to the LwM2M client node may for example be application messages, in the case of a LwM2M management server, or subsequent bootstrap messages, in the case of a LwM2M bootstrap server.

According to another aspect of the present disclosure, there is provided a method performed by a LwM2M server. The method comprises receiving a request message from a LwM2M master client node, the request message requesting the LwM2M server to perform an operation with respect to a LwM2M client node. The method further comprises receiving an instruction from the LwM2M master client node that, following completion of the operation, any subsequent messages relating to the LwM2M client node should be exchanged between the LwM2M client node and the LwM2M server. The method further comprises performing the requested operation with respect to the LwM2M client node, and, after completion of the operation, exchanging any subsequent messages relating to the LwM2M client node with the LwM2M client node. The LwM2M server may be a LwM2M management server or a LwM2M bootstrap server, and the subsequent messages relating to the LwM2M client node may be application messages, in the case of a LwM2M management server, or subsequent bootstrap messages, in the case of a LwM2M bootstrap server.

According to another aspect of the present disclosure, there is provided a method performed by a LwM2M client node. The method comprises, responsive to at least one of receipt of a confirmation message from a LwM2M master client node indicating that an operation has been completed, or deployment of the LwM2M client node, sending a message to a LwM2M management server.

According to another aspect of the present disclosure, there is provided a computer program comprising instructions which, when executed on at least one processor, cause the at least one processor to carry out a method according to any one of the aspects or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to the preceding aspect of the present disclosure.

According to another aspect of the present disclosure, there is provided a LwM2M master client node. The LwM2M master client node comprises processing circuitry configured to cause the LwM2M master client node to send a request message to a LwM2M server, the request message requesting the LwM2M server to perform an operation with respect to a LwM2M client node, and instruct the LwM2M server that, following completion of the operation, any subsequent messages relating to the LwM2M client node should be exchanged between the LwM2M client node and the LwM2M server.

According to another aspect of the present disclosure, there is provided a LwM2M server. The LwM2M server comprises processing circuitry configured to cause the LwM2M server to receive a request message from a LwM2M master client node, the request message requesting the LwM2M server to perform an operation with respect to a LwM2M client node, and to receive an instruction from the LwM2M master client node that, following completion of the operation, any subsequent messages relating to the LwM2M client node should be exchanged between the LwM2M client node and the LwM2M server. The processing circuitry is further configured to cause the LwM2M server to perform the requested operation with respect to the LwM2M client node, and after completion of the operation, exchange any subsequent messages relating to the LwM2M client node with the LwM2M client node.

According to another aspect of the present disclosure, there is provided a LwM2M client node comprising processing circuitry configured to cause the LwM2M client node to, responsive to at least one of receipt of a confirmation message from a LwM2M master client node indicating that an operation has been completed, or deployment of the LwM2M client node, send a message to a LwM2M management server.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a message flow diagram illustrating process steps in a method for operating a system comprising a LwM2M client node, a LwM2M master client node and a LwM2M management server;

FIG. 2 is a block diagram illustrating communication between entities within and outside of a system such as the system of FIG. 1;

FIG. 3 is a flow chart illustrating process steps in a method performed by a LwM2M master client node;

FIGS. 4a and 4b show a flow chart illustrating process steps in another example of method performed by a LwM2M master client node;

FIG. 5 is a flow chart illustrating process steps in a method performed by a LwM2M server;

FIG. 6 show a flow chart illustrating process steps in another example of method performed by a LwM2M server;

FIGS. 7a and 7b show a flow chart illustrating process steps in another example of method performed by a LwM2M server;

FIG. 8 is a flow chart illustrating process steps in a method performed by a LwM2M client node;

FIG. 9 is a block diagram illustrating functional units in a LwM2M master client node;

FIG. 10 is a block diagram illustrating functional units in another example of LwM2M master client node;

FIG. 11 is a block diagram illustrating functional units in a LwM2M server;

FIG. 12 is a block diagram illustrating functional units in another example of LwM2M server;

FIG. 13 is a block diagram illustrating functional units in a LwM2M client node;

FIG. 14 is a block diagram illustrating functional units in another example of LwM2M client node;

FIG. 15 is a message flow diagram illustrating registration by a LwM2M master client node on behalf of a LwM2M client node;

FIG. 16 is a message flow diagram illustrating provisioning of a LwM2M client node to a LwM2M server by a deployment application; and

FIG. 17 is a message flow diagram illustrating provisioning of a LwM2M client node to a LwM2M server by a LwM2M gateway.

### DETAILED DESCRIPTION

Much of the complexity required within a client node for that node to support LwM2M is related to the bootstrapping and registration procedures required by LwM2M. The operations involved in bootstrapping and registering a client are relatively complex and involve large payloads, so placing significant requirements on the device in terms of processing power and memory. Once bootstrapping and registration are complete, the remaining operations required of a client node, including for example reporting events, are significantly simpler, and so can be implemented even in very-constrained client devices. Aspects of the present disclosure propose to extend the LwM2M protocol so that client nodes, including for example very-constrained client nodes, can outsource the complex operations of bootstrapping and/or registration to another entity, and therefore need only implement simpler operations such as data reporting.

In order to support this outsourcing or delegation of bootstrapping and/or registration, a new LwM2M agent is proposed, referred to as a LwM2M Master Client node (LMC).

The LMC can perform registration and bootstrap commands on behalf of a LwM2M client node (LC), which may be a very constrained LC. After the relatively complex operations of bootstrapping and registration are completed, the LC acts independently, for example using the information reporting interface only, to interact with the appropriate LwM2M management server without the further involvement of the LMC.

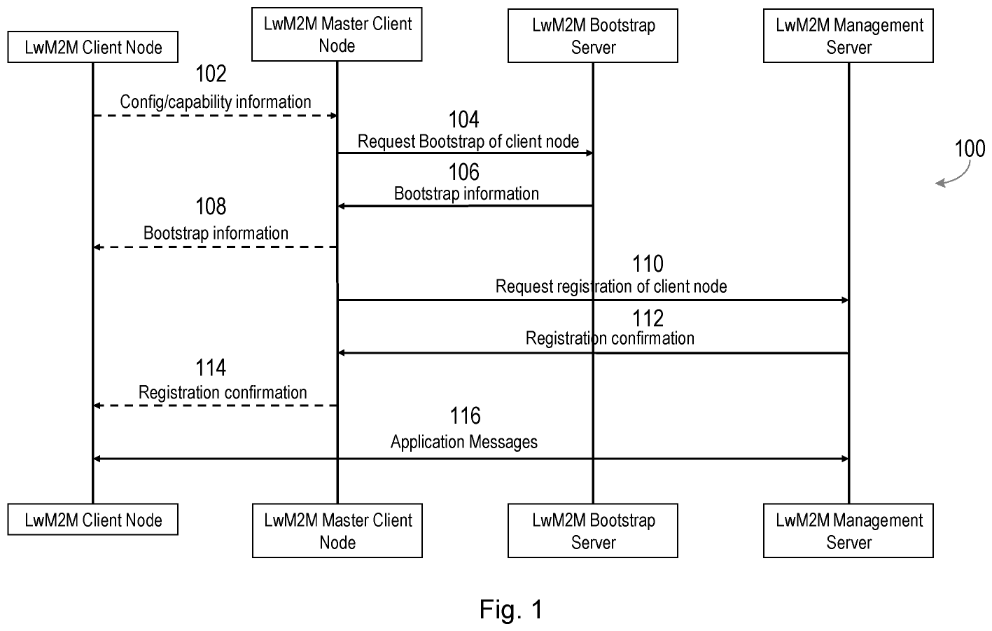

FIG. 1 is a message flow chart illustrating process steps in a method 100 for operating a system, which may be an IoT system. The system may encompass both constrained and non-constrained network domains. The system comprises a LwM2M client node, a LwM2M master client node and a LwM2M management server. The system may also comprise a LwM2M bootstrap server. With reference to FIG. 1, the method 100 may comprise, in a first step 102, the LwM2M client node sending information about the configuration and/or capabilities of the LwM2M client node to the LwM2M master client node. In step 104, the method may comprise the LwM2M master client node sending to the LwM2M bootstrap server a request to bootstrap the LwM2M client node. In step 106, the LwM2M bootstrap server may send bootstrap information for the LwM2M client node to the LwM2M master client node. In step 108, the LwM2M master client node may send to the LwM2M client node the received bootstrap information. In another example, the LwM2M master client node may send the bootstrap information to an owner, administrator or other operational authority for the LwM2M client node.

In step 110, the LwM2M master client node sends to the LwM2M management server a request to register the LwM2M client node. In step 112, the LwM2M management server confirms registration of the LwM2M client node to the LwM2M master client node. The LwM2M master client node may then confirm registration to the LwM2M client node, or to an owner, administrator or other operational authority for the LwM2M client node, in step 114. In step 116, the LwM2M management server and LwM2M client node exchange application messages. These messages may include an observe request sent by the LwM2M management server to the LwM2M client node, and reporting such as measurement reports or other messages sent by the LwM2M client node to the LwM2M management server. The messages may be sent over the Device Management and Service Enablement and/or Information Reporting LwM2M interfaces.

The method 100 of FIG. 1 illustrates how, following completion of bootstrapping and/or registration of the LwM2M client node by the LwM2M master client node, the LwM2M master client node is not involved in the exchange of application messages between the LwM2M client node and the LwM2M management server (or the exchange of any subsequent bootstrapping messages between the LwM2M client node and the LwM2M bootstrap server). The LwM2M client node delegates the tasks of bootstrapping and/or registering to the LwM2M master client node, and then operates independently of the LwM2M master client node once these procedures are completed. Configuration messages for the bootstrapping and registration of the LwM2M client node are thus exchanged between the LwM2M master client node and the appropriate LwM2M server, but subsequent messages do not pass via the LwM2M master client node, being exchanged between the LwM2M client node and the appropriate LwM2M server. It will be appreciated that this operation differs from a gateway arrangement, according to which a gateway may present the resources hosted on a LwM2M client node as its own resources during registration. The gateway will then remain in the network path between the LwM2M client node and the LwM2M servers, exchanging application messages or subsequent bootstrap messages relating to the LwM2M client node with the LwM2M server.

According to examples of the present disclosure, the LwM2M master client node is provisioned with credentials that allow it to contact the LwM2M bootstrap server and LwM2M management server on behalf of the LwM2M client node. This provisioning may be achieved by, for example, issuing an authorisation token such as a certificate or web token to the LwM2M master client node that delegates these rights to the LwM2M master client node. In addition, the LwM2M master client node may be configured with information about the LwM2M client node's capabilities and configuration so that the LwM2M master client node can perform the initial bootstrap and registration processes on behalf of the LC.

When the LwM2M master client node performs registration of the LwM2M client node with a LwM2M management server, it presents the authorisation token that indicates the endpoint identifier of the LwM2M client node. The certificate or web token is authorised, for example by means of cryptographic signature, by a party trusted by the LwM2M management server, as discussed in further detail below. The LwM2M master client node also provides an indication of the credentials of the LwM2M client node (for example, a fingerprint of the public key of the LwM2M client node) and may provide the IP address of the LwM2M client node. The IP address of the LwM2M client node may be useful if the device is such that initial communication after the registration is initiated by the server. Alternatively or in addition, the server may use the IP address for access control purposes, for example if the LwM2M client node does not have secure credentials but network security is used so that the IP address is “trusted”. A new master client mode of operation within a LwM2M bootstrap server and LwM2M management server is proposed herein to reflect this behaviour and is discussed below.

In some operational scenarios, a LwM2M client node may be so simple or constrained that it can only send essentially fixed messages with a small variable part, for example a measurement value. The LwM2M client node may even be unable to receive CoAP messages, and the configuration of the LwM2M client node, including for example where to send notifications, could be performed at manufacture time. An administrator of the LwM2M client node may only be able to turn on and turn off the LwM2M client node, and the LwM2M master client node may therefore be unable to report any error conditions in the registration to the LwM2M client node. An administrator may therefore chose to delay deployment of the LwM2M client node until the registration process performed by the LwM2M master client node completes successfully. Successful completion of registration may be reported by the LwM2M master client node to the administrator.

Some operational scenarios may involve LwM2M client nodes that are more complex, while remaining significantly constrained. Such LwM2M client nodes may support a simple form of communication with the LwM2M master client node. In these cases, the LwM2M client node may send its own configuration information to the LwM2M master client node and the LwM2M master client node may inform the LwM2M client node when the registration process is complete. The LwM2M client node—LwM2M master client node communication may take place for example over a simple short-range radio connection (such as RFID) that does not require complex security mechanisms.

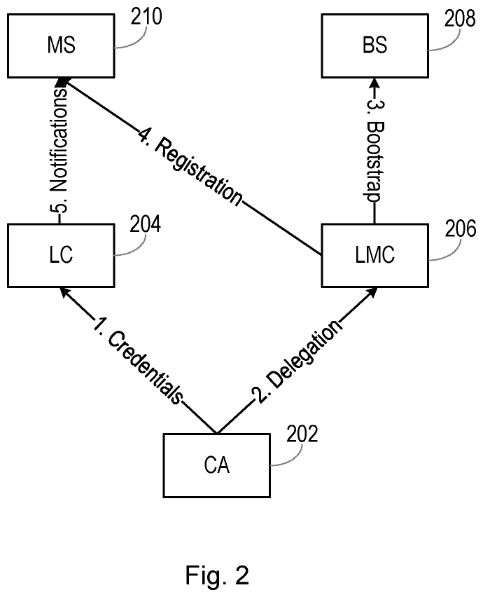

FIG. 2 is a block diagram illustrating communication between system and other entities according to one example of the present disclosure. As illustrated in FIG. 2, an authority, such as a certification authority 202, provides the LwM2M client node 204 with its credentials in step 1. The authority 202 also provides the LwM2M master client node 206 with credentials in step 2 that allow the LwM2M master client node to prove that it is authorized to perform the bootstrap and registration procedures on behalf of the LwM2M client node. The LwM2M master client node 206 performs bootstrap and registration procedures in steps 3 and 4 on behalf of the LwM2M client node and with the LwM2M bootstrap server 208 and LwM2M management server 210. Once the bootstrap and registration procedures are complete, the LwM2M client node can send application messages such as notifications to the LwM2M management server 210 in step 5.

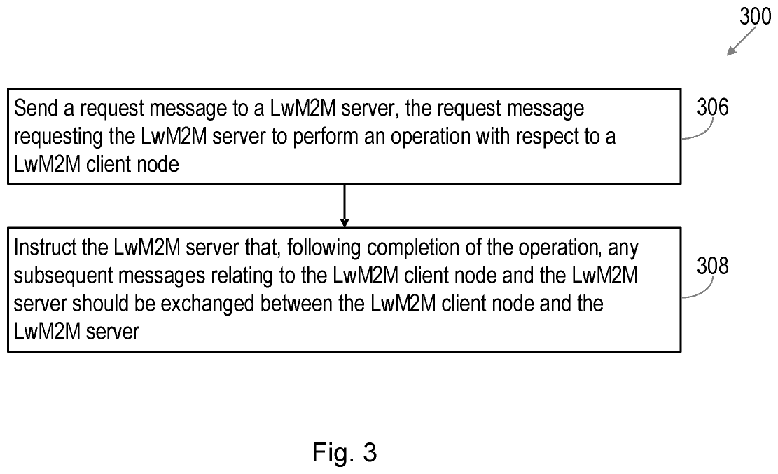

FIGS. 3 to 8 are flow charts illustrating process steps in methods performed by a LwM2M master client node, LwM2M server such as a LwM2M bootstrap server or a LwM2M management server and a LwM2M client node. It will be appreciated that the methods described, performed by the respective nodes and servers, may together result in a system method such as the method 100 described above.

FIG. 3 is a flow chart illustrating process steps in a method 300 performed by a LwM2M master client node. The LwM2M master client node may be a physical or virtual node. Referring to FIG. 3, the method comprises, in step 306, sending a request message to a LwM2M server, the request message requesting the LwM2M server to perform an operation with respect to a LwM2M client node. The method further comprises, in step 308, instructing the LwM2M server that, following completion of the operation, any subsequent messages relating to the LwM2M client node should be exchanged between the LwM2M client node and the LwM2M server. The subsequent messages relating to the LwM2M client node may for example be application messages, in the case of a LwM2M server comprising a LwM2M management server, or subsequent bootstrap messages, in the case of a LwM2M server comprising a LwM2M bootstrap server.

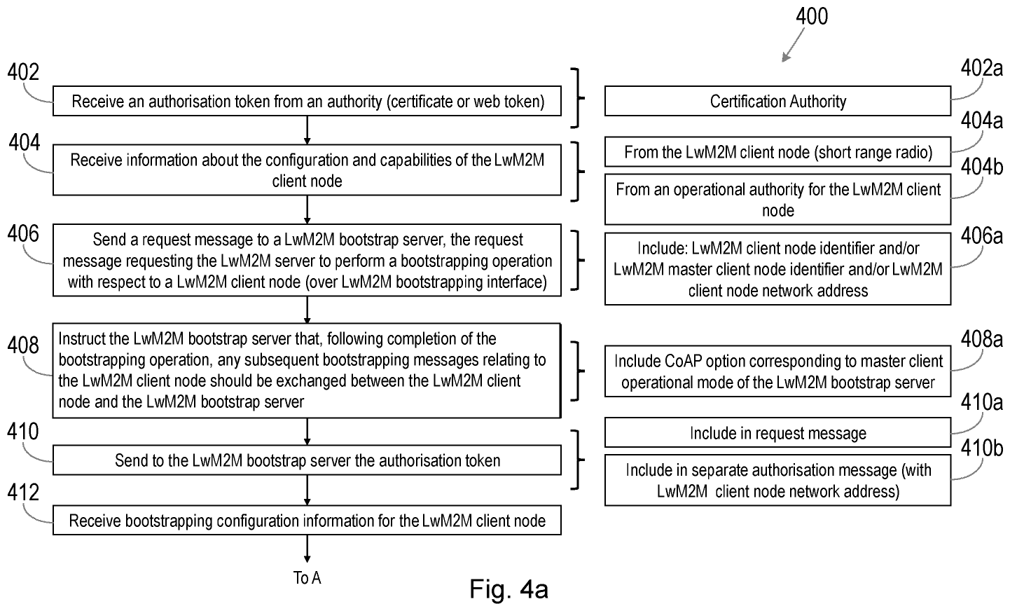

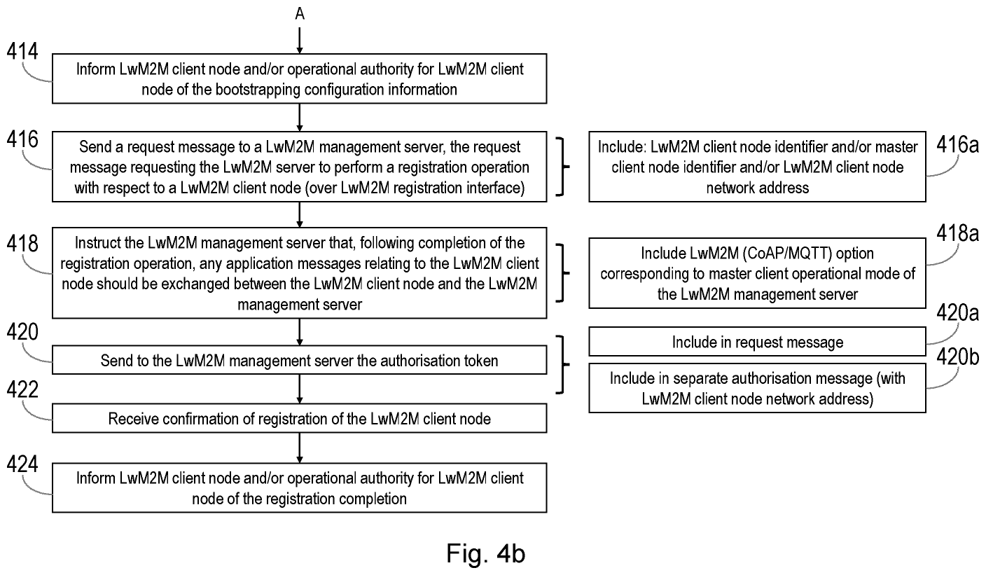

As discussed above, the LwM2M client node may be a constrained node and may be operable to connect to a constrained network. The LwM2M server may be a virtualized function running in a cloud deployment, and may comprise a LwM2M bootstrap server or a LwM2M management server. In one example, the method 300 is repeated towards both a LwM2M bootstrap server and a LwM2M management server, as illustrated in FIGS. 4a and 4b.

FIGS. 4a and 4b show a flow chart illustrating process steps in another example of method 400 performed by a LwM2M master client node. As for the method 300, the LwM2M master client node may comprise a physical or virtual node. The steps of the method 400 illustrate an example way in which the steps of the method 300 may be implemented and supplemented in order to achieve the above discussed and additional functionality.

Referring initially to FIG. 4a, in a first step 402, the LwM2M master client node receives an authorization token from an authority. The authority may for example comprise a Certification Authority or a web token issuer, as discussed below. The authorisation token is operable to certify that the LwM2M master client node is authorised to request the LwM2M server to perform an operation with respect to the LwM2M client node. The token may for example comprise a certificate such as an X.509 certificate issued by a Certification Authority, or a web token such as a CBOR web token or a JSON web token. As illustrated at 402a, in the case of an authorisation token in the form of a certificate, the authority from which it is received may comprise a Certification Authority. In the case of a web token, the authority may comprise an issuer of the token. The authority may be an owner of the client node or may be a third party. The authority is an entity trusted to authorise actions on behalf of the client node, and the authorisation token includes content (for example a cryptographic signature) to prove that the token has been issued by the trusted authority.

In step 404, the LwM2M master client node receives information about the configuration and capabilities of the LwM2M client node, which information may be used by the LwM2M master client node to perform bootstrapping and registration of the LwM2M client node on behalf of the LwM2M client node. As illustrated at 404a, this information may be received by the LwM2M master client node from the LwM2M client node, for example of short range radio, or may be received from an operational authority for the LwM2M client node, such as an administrator, as illustrated at 404b. In another example, the configuration and capabilities information may be configured in the LwM2M master client node.

In step 406, the LwM2M master client node sends a request message to a LwM2M bootstrap server, the request message requesting the LwM2M server to perform a bootstrapping operation with respect to a LwM2M client node. The request message may be a CoAP message or an MQTT message, and is sent over the LwM2M bootstrapping interface, which is the interface that would be used by the client node for this purpose, if the client node were to perform the bootstrapping operation for itself.

Step 406b illustrates different information that may be included in the bootstrap request message sent at step 406. The bootstrap request message may include an identification of the LwM2M client node, which identifier may be an endpoint identifier of the client node. The request message may further include a network address for the LwM2M client node. In some examples, the LwM2M master client node may send an identification or address of the client node in a separate message.

The request message may further include an identification of the LwM2M master client node. If security (for example Datagram Transport Layer Security (DTLS)) is used, this will ensure that the request message will identify the LwM2M master client node as the sender of the message. In addition, an IP address is operable to identify the sender of a message in certain cases, such as in a fully end-to-end trusted network without Network Address Translators (NATs). However, according to examples of the present disclosure, the request message may explicitly specify that the included sender identity is the identity of the master client node that is requesting bootstrapping on behalf of a LwM2M client node, and is not the identity of a LwM2M client node requesting bootstrapping for itself.

In step 408, the LwM2M master client node instructs the LwM2M bootstrap server that, following completion of the operation, any subsequent bootstrap messages relating to the LwM2M client node should be exchanged between the LwM2M client node and the LwM2M bootstrap server. As illustrated in step 408a, this may comprise including in the bootstrap request message sent in step 406 a LwM2M option corresponding to a master client operational mode of the LwM2M bootstrap server. The option may for example be a CoAP option, if the request message is a CoAP message. In some examples, the option may be an explicit option such as a flag. In other examples, the option may be implicit, its inclusion implied by the inclusion of both a LwM2M client node identifier and a LwM2M master client node identifier. In still further examples, a separate message type may be defined for requesting bootstrapping (and/or registration) by a LwM2M master client node on behalf of a LwM2M client node. Example request messages and options are discussed below with reference to a message requesting registration of the LwM2M client node. The options discussed below apply equally to a bootstrap request message sent at step 406 of the present method.

A master client operational mode of the LwM2M bootstrap server comprises an operational mode according to which an operation relating to a LwM2M client node is performed on behalf of the LwM2M client node by a LwM2M master client node, and, following completion of the operation, any subsequent bootstrap messages relating to the LwM2M client node (for example when re-bootstrapping the LwM2M client node) are exchanged between the LwM2M bootstrap server and the LwM2M client node.

In step 410, the LwM2M master client node sends to the LwM2M bootstrap server the authorisation token received in step 402 and operable to certify that the LwM2M master client node is authorised to request the LwM2M bootstrap server to perform the bootstrapping operation with respect to the LwM2M client node. As illustrated at step 410a and 410b, sending the authorisation token may comprise including the authorisation token in the request message or sending an authorisation message to the LwM2M bootstrap server and including the authorisation token in the authorisation message. In some examples, an IP address for the LwM2M client node may also be included in the authorisation message.

In step 412, the LwM2M master client node receives from the LwM2M bootstrap server confirmation of completion of the bootstrapping, which confirmation may take the form of configuration information for the client node.

Referring now to FIG. 4b, in step 414, the LwM2M master client node informs at least one of the LwM2M client node or an operating authority of completion of the bootstrapping operation for example by forwarding the received configuration information for the LwM2M client node to at least one of the LwM2M client node or the operating authority.

In step 416, the LwM2M master client node sends a request message to a LwM2M management server, the request message requesting the LwM2M server to perform a registration operation with respect to a LwM2M client node. This message may be a CoAP message or an MQTT message and may be sent over the LwM2M registration interface. In step 418, the LwM2M master client node instructs the LwM2M management server that, following completion of the registration operation, any application messages relating to the LwM2M client node should be exchanged between the LwM2M client node and the LwM2M management server. As discussed above with reference to the bootstrapping request message and illustrated at 416a, the registration request message may include an identifier for the LwM2M client node, an identifier for the LwM2M master client node, and a network address for the LwM2M client node. Including the network address of the LwM2M client node may enable the LwM2M management server to ensure that messages from that address are accepted (for example if DTLS is not used and so the IP address alone is used to ensure messages originate from the right client node).

Also as discussed above with reference to the bootstrapping request and illustrated at 418a, instructing the LwM2M management server regarding exchange of application messages with the LwM2M client node may comprise including a LwM2M option corresponding to a master client operational mode of the LwM2M management server in the registration request message. The details regarding the inclusion of an option in the bootstrapping request message discussed above also apply to the inclusion of an option in a registration message.

In step 420, the LwM2M master client node sends to the LwM2M management server the authorisation token received in step 402 and operable to certify that the LwM2M master client node is authorised to request the LwM2M server to perform the registration operation with respect to the LwM2M client node. As illustrated at step 420a and 420b, sending the authorisation token may comprise including the authorisation token in the request message or sending an authorisation message to the LwM2M management server and including the authorisation token in the authorisation message. In some examples, an IP address for the LwM2M client node may also be included in the authorisation message.

An example of a simple form of registration request message that may be sent by a LwM2M master client node in step 416 is illustrated below, followed by a corresponding standard registration request message:

Example Message According to the Present Disclosure:

CoAP method: POST

URI options: /rd/?cep=example-client-42

Payload: </1/1>,</1/2>,</2/0>,</3/0>,</4/0>

Example Message for Standard Registration Procedure:

CoAP method: POST

URI options: /rd/?ep=example-client-42

Payload: </1/1>,</1/2>,</2/0>,</3/0>,</4/0>

The example registration request message according to the present disclosure uses a new “cep” option (Client EndPoint) to denote that registration is requested on behalf of another node. This option would trigger the LwM2M management server to operate in the new master client operational mode, anticipating exchange of application messages with the client node itself and not with the master client node that sent the registration request message. If the LwM2M client node creates a DTLS connection that uses the given ID (example-client-42) and is using the certificate mode of DTLS that binds the ID to a trust anchor (e.g., CA), and the LwM2M, master client node is well trusted, this may provide sufficient evidence that the LwM2M master client node was authorised to request registration. However, in a majority of practical scenarios it may be desirable to include an explicit authorization token to certify that the LwM2M master client node is authorized to request registration.

In order to deliver the authorisation token, the registration request message could be extended with a container for the authorisation token in the payload. The payload would therefore be “CoRE Multipart” or of a new content format, and contain both the original CoRE weblink payload shown above and also the authorisation token. In other examples, as discussed above, a separate message may be used to deliver the authorisation token, for example:

POST /rd/auth-lmc

Payload: [authorisation token]

As discussed the authorisation token may be a certificate such as an X.509 certificate issued by a Certificate Authority. Alternatively, the authorisation token may comprise a web token such as a CBOR Web Token as set out in RFC8392 or a JSON Web Token as set out in RFC7519. Such tokens are becoming increasingly popular for delivering claims such as “A is authorized to do X on B”.

Also as discussed above, the address of the LwM2M client node may be included in the registration request message, for example as a URI option in the registration request message. Alternatively, for example if the authorisation token is to be delivered in a separate message, the LwM2M master client node could deliver the LwM2M client node address as part of a standardized payload with the authorisation token. An example of LwM2M client node address as a URI option, using “cip” to deliver the IP address, is illustrated below:

URI options: /rd/?cep=example-client?cip=192.0.2.42

Referring still to FIG. 4b, in step 422, the LwM2M master client node receives confirmation of registration of the LwM2M client node and, in step 424, the LwM2M master client node informs at least one of the LwM2M client node or the operational authority for the LwM2M client node of completion of registration. As discussed above, in examples of LwM2M client nodes that are very simple, an operational authority for the LwM2M client node may await confirmation of successful registration before deploying or turning on the LwM2M client node in the field.

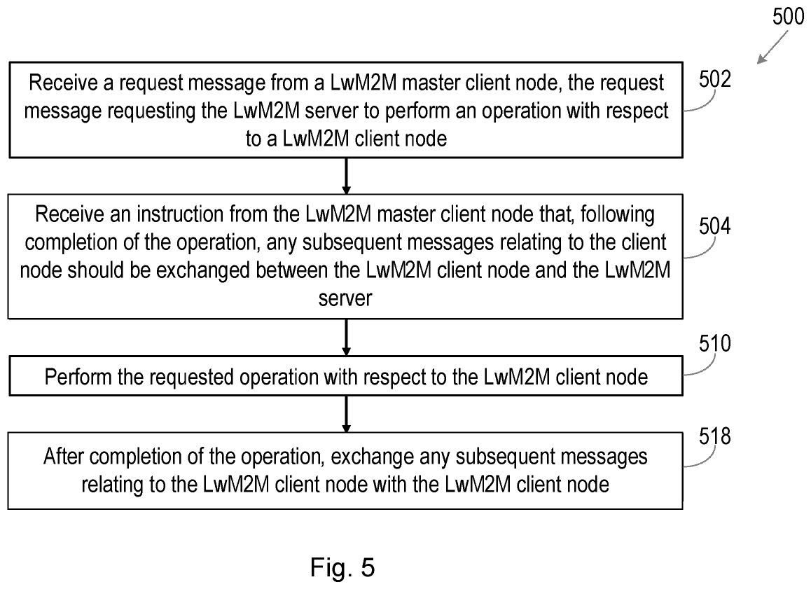

FIG. 5 is a flow chart illustrating process steps in a method 500 performed by a LwM2M server. The LwM2M server may be a physical server or may be a virtualized function running in a cloud deployment. The LwM2M server may comprise a LwM2M bootstrap server or a LwM2M management server. Referring to FIG. 5, the method comprises, in step 502, receiving a request message from a LwM2M master client node, the request message requesting the LwM2M server to perform an operation with respect to a LwM2M client node. In step 504, the method comprises receiving an instruction from the LwM2M master client node that, following completion of the operation, any subsequent messages relating to the LwM2M client node should be exchanged between the LwM2M client node and the LwM2M server. In step 510 the method comprises performing the requested operation with respect to the LwM2M client node. In step 518, the method comprises, after completion of the operation, exchanging any subsequent messages relating to the LwM2M client node with the LwM2M client node. The subsequent messages relating to the LwM2M client node may for example be application messages, in the case of a LwM2M server comprising a LwM2M management server, or subsequent bootstrap messages, in the case of a LwM2M server comprising a LwM2M bootstrap server.

As discussed above, the LwM2M client node may be a constrained node and may be operable to connect to a constrained network. The LwM2M master client node may be a physical or virtual node.

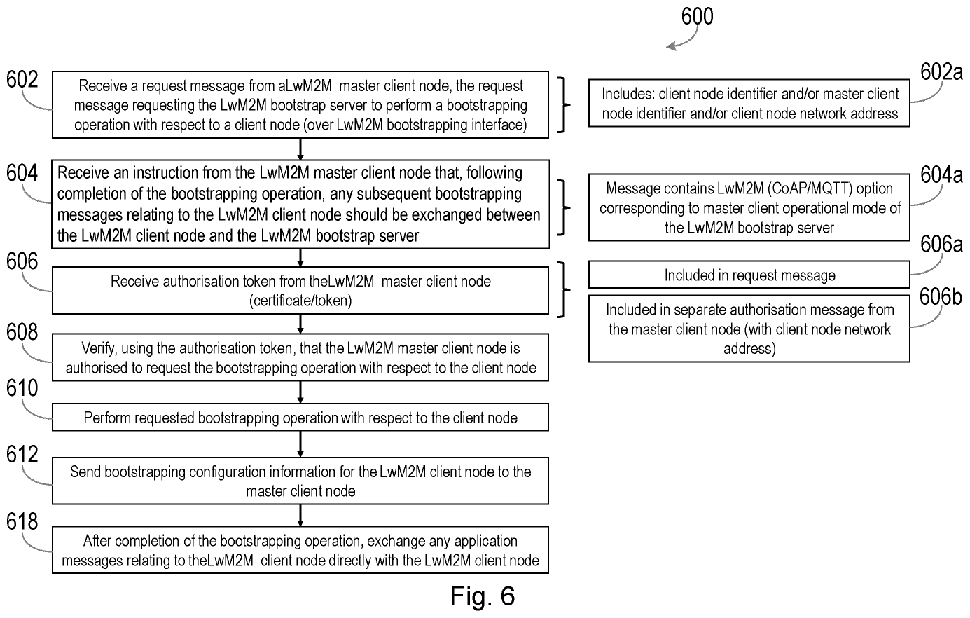

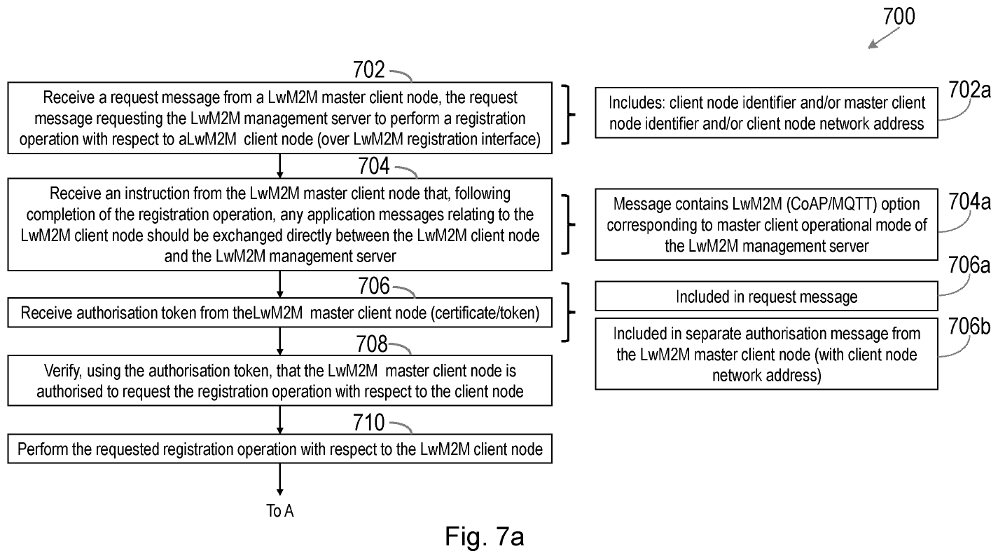

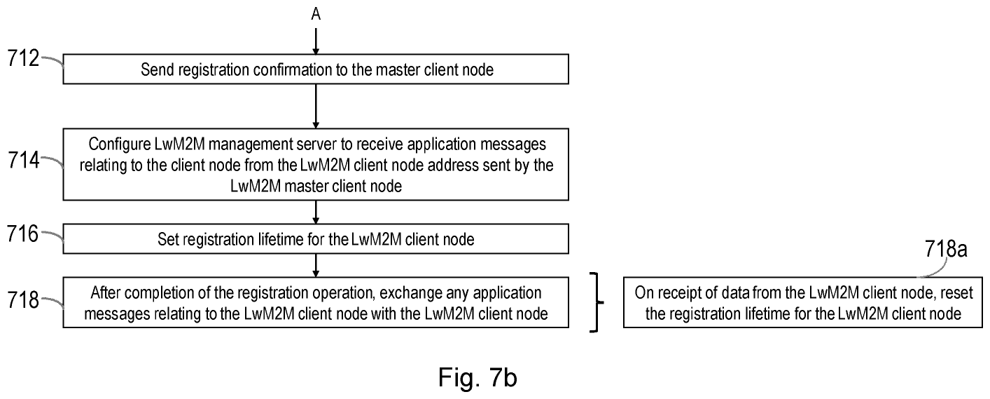

FIGS. 6, 7a and 7b show flow charts illustrating process steps further examples of methods 600, 700 performed by a LwM2M server, which may be a physical server or a virtualised function. The steps of the method 600 illustrate an example way in which the steps of the method 500 may be implemented and supplemented in a LwM2M bootstrap server in order to achieve the above discussed and additional functionality. The steps of the method 700 illustrate an example way in which the steps of the method 500 may be implemented and supplemented in a LwM2M management server in order to achieve the above discussed and additional functionality.

Referring initially to FIG. 6, in a method 600 performed by a LwM2M bootstrap server, in a first step 602, the LwM2M bootstrap server receives a request message from a LwM2M master client node, the request message requesting the LwM2M server to perform a bootstrapping operation with respect to a LwM2M client node. The message may be a CoAP message or a MQTT message and is received over the LwM2M bootstrapping interface. As illustrated at step 602a, the request message may include a LwM2M client node identifier, a network address for the client node, and an identification of the master client node. Details of the contents of the bootstrap request message are discussed above with reference to the method 400 performed by a LwM2M master client node, and are not repeated here.

In step 604, the LwM2M bootstrap server receives an instruction from the LwM2M master client node that, following completion of the bootstrapping operation, any subsequent bootstrap messages relating to the LwM2M client node should be exchanged between the LwM2M client node and the LwM2M bootstrap server. As illustrated in 604a, this may comprise receiving in the bootstrap request message a LwM2M option corresponding to a master client operational mode of the LwM2M bootstrap server. As discussed above, a master client operation mode is an operational mode according to which an operation relating to a LwM2M client node is performed on behalf of the LwM2M client node by a LwM2M master client node, and any subsequent messages relating to the LwM2M client node and exchanged after completion of the operation are exchanged with the LwM2M client node. In the case of a LwM2M bootstrap server, such subsequent messages relating to the LwM2M client node may for example comprise messages relating to re-bootstrapping of the LwM2M client node. The details regarding the inclusion of an option in a bootstrapping request message are discussed above with reference to method 400 and consequently are not repeated here.

In step 606, the LwM2M bootstrap server receives from the LwM2M master client node an authorisation token, the authorisation token operable to certify that the LwM2M master client node is authorised to request the LwM2M server to perform the bootstrap operation with respect to the LwM2M client node. As illustrated in 606a and 606b, the authorisation token may be received in the request message or in a separate authorisation message from the LwM2M master client node. The authorisation token may be a certificate issued by a Certification Authority a web token, as discussed above with reference to method 400.

In step 608, the LwM2M bootstrap server verifies, using the authorisation token, that the LwM2M master client node is authorised to request the bootstrap operation with respect to the LwM2M client node. If no authorisation token is received from the master client node, the LwM2M bootstrap server may still seek to verify authorisation of the LwM2M master client node by confirming a trust relationship established with the master client node. In step 610, the LwM2M bootstrap server performs bootstrapping of the LwM2M client node and in step 612, the LwM2M bootstrap server sends to the LwM2M master client node confirmation of completion of the operation. The confirmation may be in the form of configuration information for the LwM2M client node. In step 618, after completion of the operation, the LwM2M bootstrap server exchanges any subsequent bootstrap messages relating to the LwM2M client node (such as during re-bootstrapping) with the LwM2M client node, and thus the LwM2M master client node is not involved in the exchange of such messages.

FIG. 7 illustrates process steps in an example method 700 performed by a LwM2M management server. Many of the steps in method 700 performed by the LwM2M management server are similar to corresponding steps in method 600 performed by a LwM2M bootstrap server. Details of such steps are not repeated here but may be found in the preceding discussion of methods 400 and 600.

Referring initially to FIG. 7a, in a first step 702, the LwM2M management server receives a request message from a LwM2M master client node, the request message requesting the LwM2M server to perform a registration operation with respect to a LwM2M client node. The message may be a CoAP message or a MQTT message and is received over the LwM2M registration interface. As illustrated at step 702a, the request message may include a LwM2M client node identifier, a network address for the client node, and an identification of the master client node. Details of the contents of the registration request message are discussed above with reference to the method 400 performed by a LwM2M master client node.

In step 704, the LwM2M management server receives an instruction from the LwM2M master client node that, following completion of the registration operation, any application messages relating to the LwM2M client node should be exchanged between the LwM2M client node and the LwM2M bootstrap server. Such messages may include an observe request sent by the LwM2M management server and reporting messages sent by the LwM2M client node. As illustrated in 704a, receiving this instruction may comprise receiving in the registration request message a LwM2M option corresponding to a master client operational mode of the LwM2M management server. The details regarding the inclusion of an option in a registration request message are discussed above with reference to method 400.

In step 706, the LwM2M management server receives from the LwM2M master client node an authorisation token, the authorisation token operable to certify that the LwM2M master client node is authorised to request the LwM2M server to perform the registration operation with respect to the LwM2M client node. As illustrated in 706a and 706b, the authorisation token may be received in the request message or in a separate authorisation message from the LwM2M master client node. The authorisation token may be a certificate issued by a Certification Authority a web token, as discussed above with reference to method 400.

In step 708, the LwM2M management server verifies, using the authorisation token, that the LwM2M master client node is authorised to request the registration operation with respect to the LwM2M client node. If no authorisation token is received from the master client node, the LwM2M management server may still seek to verify authorisation of the LwM2M master client node by confirming a trust relationship established with the master client node. In step 710, the LwM2M management server performs registration of the LwM2M client node.

Referring now to FIG. 7b, in step 712, the LwM2M management server sends confirmation that the registration has been completed to the LwM2M master client node. In step 714, the LwM2M management server configured itself to accept incoming application messages, such as reporting messages, relating to the LwM2M client node from a client node network address included in the request message (and consequently not from the address of the LwM2M master client node). In step 716, the LwM2M management server sets a registration lifetime for the LwM2M client node. The registration lifetime may be set to a value included in the registration request message. For example, registration URI options may also contain the standard “registration lifetime” option, e.g., “It=86400”.

In step 716, after completion of the registration operation, the LwM2M management server exchanges any application messages related to the LwM2M client node with the LwM2M client node. Such messages may comprise reporting messages. As illustrated in step 718a, on receipt of on receipt of data from the LwM2M client node, the LwM2M management server may reset the registration lifetime of the LwM2M client node. Existing practices envisage a refreshing of registration of the LwM2M client node with a re-registration. By resetting the registration lifetime of the LwM2M client node when data is received from the client node, the LwM2M management server may avoid the need for re-registration by the LwM2M master client node. This resetting of the lifetime, together with performing registration by exchanging messages with a LwM2M master client node and then exchanging subsequent application messages with the LwM2M client node, may form part of the master client mode of operation of the LwM2M management server.

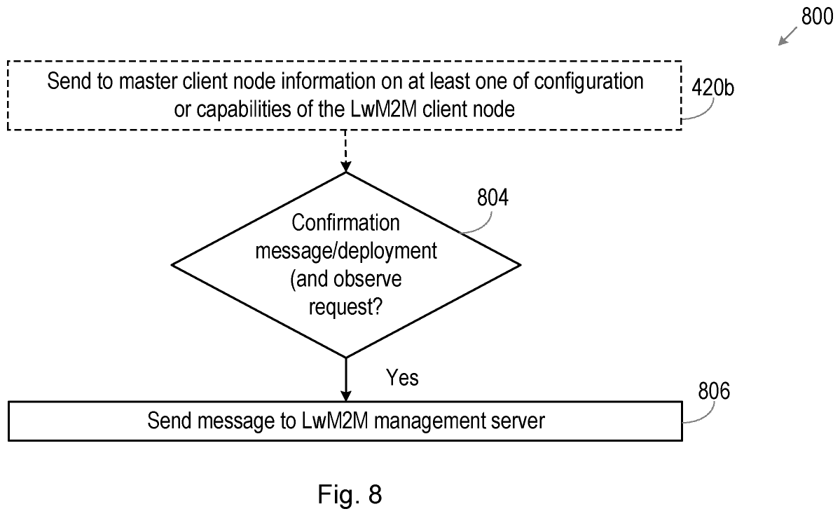

FIG. 8 illustrates process steps in a method 800 performed by a LwM2M client node. In a first step 802, the LwM2M client node may send to a LwM2M master client node information on at least one of configuration or capabilities of the LwM2M client node. The LwM2M client node may send the information over short range radio connection. In step 804, the LwM2M client node checks whether either a confirmation message has been received from a LwM2M master client node indicating that an operation has been completed, or deployment of the LwM2M client node has taken place. Deployment may comprise activation of the client node in an operational environment. In some examples, the LwM2M client node may additionally wait for an observe request to be received from a LwM2M management server. Responsive to receipt of the confirmation message (and observe request) or deployment of the LwM2M client node, the LwM2M client node sends a message to a LwM2M management server. The message may be an application message such as a reporting message. In a further step (not shown), the LwM2M client node may exchange messages with a LwM2M bootstrap server, the messages relating to re-bootstrapping of the LwM2M client node.

As discussed above, the methods 300, 400, 500, 600, 700 and 800 are performed by a LwM2M master client node, LwM2M server and LwM2M client node respectively. The present disclosure provides a LwM2M master client node, a LwM2M server and a LwM2M client node that are adapted to perform any or all of the steps of the above discussed methods.

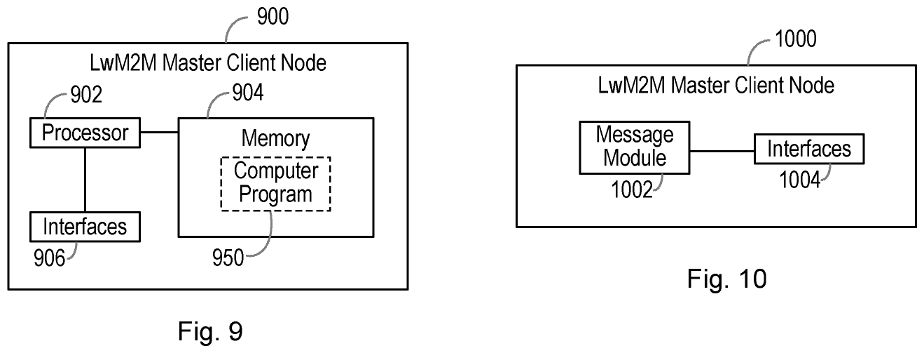

FIG. 9 is a block diagram illustrating an example LwM2M master client node 900 which may implement the method 300 and/or 400 according to examples of the present disclosure, for example on receipt of suitable instructions from a computer program 950. Referring to FIG. 9, the LwM2M master client node 900 comprises a processor or processing circuitry 902, and may comprise a memory 904 and interfaces 906. The processing circuitry 902 may be operable to perform some or all of the steps of the method 300 and/or 400 as discussed above with reference to FIGS. 3, 4a and 4b. The memory 904 may contain instructions executable by the processing circuitry 902 such that the LwM2M master client node 900 is operable to perform some or all of the steps of the method 300 and/or 400. The instructions may also include instructions for executing one or more telecommunications and/or data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive etc.

FIG. 10 illustrates functional units in another example of LwM2M master client node 1000 which may execute examples of the methods 300 and/or 400 of the present disclosure, for example according to computer readable instructions received from a computer program. It will be understood that the units illustrated in FIG. 10 are functional units, and may be realised in any appropriate combination of hardware and/or software. The units may comprise one or more processors and may be integrated to any degree.

Referring to FIG. 10, the LwM2M master client node 1000 comprises a message module 1002 for sending a request message to a LwM2M server, the request message requesting the LwM2M server to perform an operation with respect to a LwM2M client node. The message module 1002 is also for instructing the LwM2M server that, following completion of the operation, any subsequent messages relating to the LwM2M client node should be exchanged between the LwM2M client node and the LwM2M server. The LwM2M master client node 1000 may also comprise interfaces 1002.

The LwM2M master client node may be a physical node or may be implemented as a virtual node in the cloud, provided network constrains of a particular deployment allow for this.

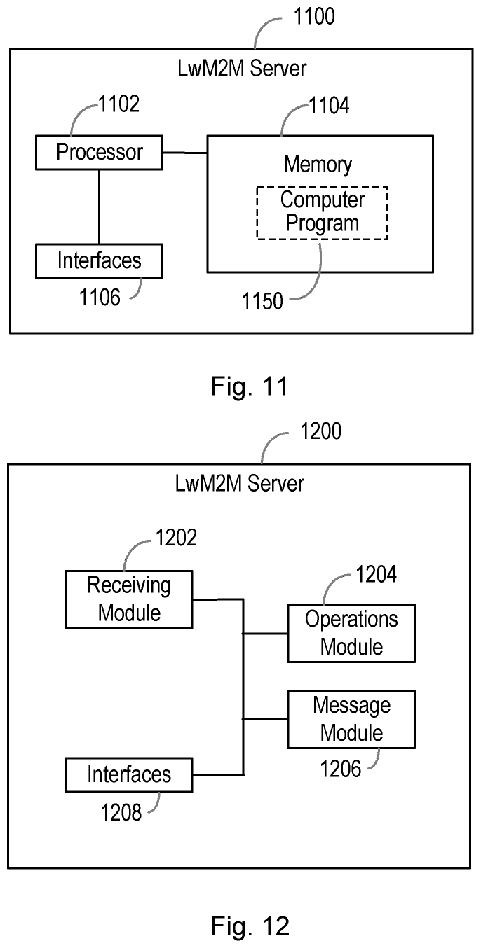

FIG. 11 is a block diagram illustrating an example LwM2M server 1100 which may implement the method 500, 600 and/or 700 according to examples of the present disclosure, for example on receipt of suitable instructions from a computer program 1150. Referring to FIG. 11, the LwM2M server 1100 comprises a processor or processing circuitry 1102, and may comprise a memory 1104 and interfaces 1106. The processing circuitry 1102 may be operable to perform some or all of the steps of the method 500, 600 and/or 700 as discussed above with reference to FIGS. 5, 6 and 7. The memory 1104 may contain instructions executable by the processing circuitry 1102 such that the LwM2M server 1100 is operable to perform some or all of the steps of the method 500, 600 and/or 700. The instructions may also include instructions for executing one or more telecommunications and/or data communications protocols. The instructions may be stored in the form of the computer program 1150. In some examples, the processor or processing circuitry 1102 may include one or more microprocessors or microcontrollers, as well as other digital hardware, which may include digital signal processors (DSPs), special-purpose digital logic, etc. The processor or processing circuitry 1102 may be implemented by any type of integrated circuit, such as an Application Specific Integrated Circuit (ASIC), Field Programmable Gate Array (FPGA) etc. The memory 1104 may include one or several types of memory suitable for the processor, such as read-only memory (ROM), random-access memory, cache memory, flash memory devices, optical storage devices, solid state disk, hard disk drive etc.

FIG. 12 illustrates functional units in another example of LwM2M server 1200 which may execute examples of the methods 500, 600 and/or 700 of the present disclosure, for example according to computer readable instructions received from a computer program. It will be understood that the units illustrated in FIG. 12 are functional units, and may be realised in any appropriate combination of hardware and/or software. The units may comprise one or more processors and may be integrated to any degree.

Referring to FIG. 12, the LwM2M server 1200 comprises a receiving module 1202 for receiving a request message from a LwM2M master client node, the request message requesting the LwM2M server to perform an operation with respect to a LwM2M client node. The receiving module 1202 is also for receiving an instruction from the LwM2M master client node that, following completion of the operation, any subsequent messages relating to the LwM2M client node should be exchanged between the LwM2M client node and the LwM2M server. The LwM2M server further comprises an operations module 1204 for performing the requested operation with respect to the LwM2M client node, and a message module 1206 for, after completion of the operation, exchanging any subsequent messages relating to the LwM2M client node with the LwM2M client node. The LwM2M server 1200 may also comprise interfaces 1208.

It will be appreciated that the LwM2M server 1100, 1200 may be virtualised network functions deployed in the cloud

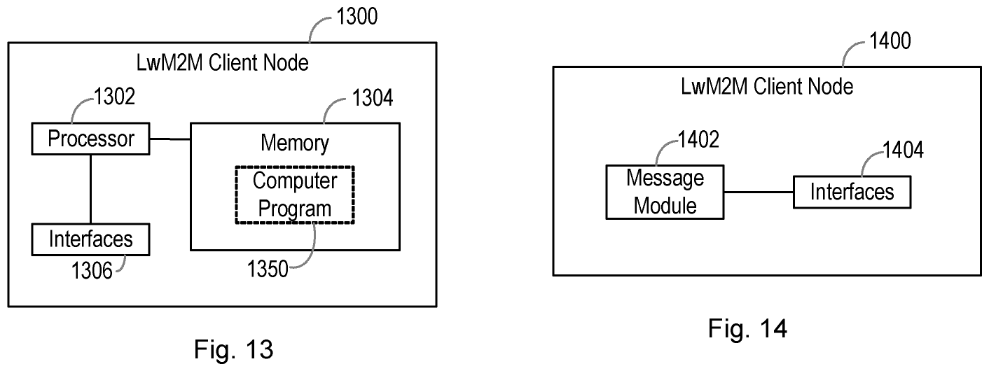

FIG. 13 is a block diagram illustrating an example LwM2M client node 1300 which may implement the method 800 according to examples of the present disclosure, for example on receipt of suitable instructions from a computer program 1350. Referring to FIG. 13, the LwM2M client node 1300 comprises a processor or processing circuitry 1302, and may comprise a memory 1304 and interfaces 1306. The processing circuitry 1302 may be operable to perform some or all of the steps of the method 800 as discussed above with reference to FIG. 8. The memory 1304 may contain instructions executable by the processing circuitry 1302 such that the LwM2M client node 1300 is operable to perform some or all of the steps of the method 800. The instructions may also include instructions for executing one or more telecommunications and/or data communications protocols. The instructions may be stored in the form of the computer program 1350. In some examples, the processor or processing circuitry 1302 may include one or more microprocessors or microcontrollers, as well as other digital hardware, which may include digital signal processors (DSPs), special-purpose digital logic, etc. The processor or processing circuitry 1302 may be implemented by any type of integrated circuit, such as an Application Specific Integrated Circuit (ASIC), Field Programmable Gate Array (FPGA) etc. The memory 1304 may include one or several types of memory suitable for the processor, such as read-only memory (ROM), random-access memory, cache memory, flash memory devices, optical storage devices, solid state disk, hard disk drive etc.

FIG. 14 illustrates functional units in another example of LwM2M client node 1400 which may execute examples of the method 800 of the present disclosure, for example according to computer readable instructions received from a computer program. It will be understood that the units illustrated in FIG. 14 are functional units, and may be realised in any appropriate combination of hardware and/or software. The units may comprise one or more processors and may be integrated to any degree.

Referring to FIG. 14, the LwM2M client node 1400 comprises a message module 1402 for, responsive to at least one of receipt of a confirmation message from a LwM2M master client node indicating that an operation has been completed, or deployment of the LwM2M client node, sending an application message to a LwM2M management server. The LwM2M client node 1400 may further comprise interfaces 1408.

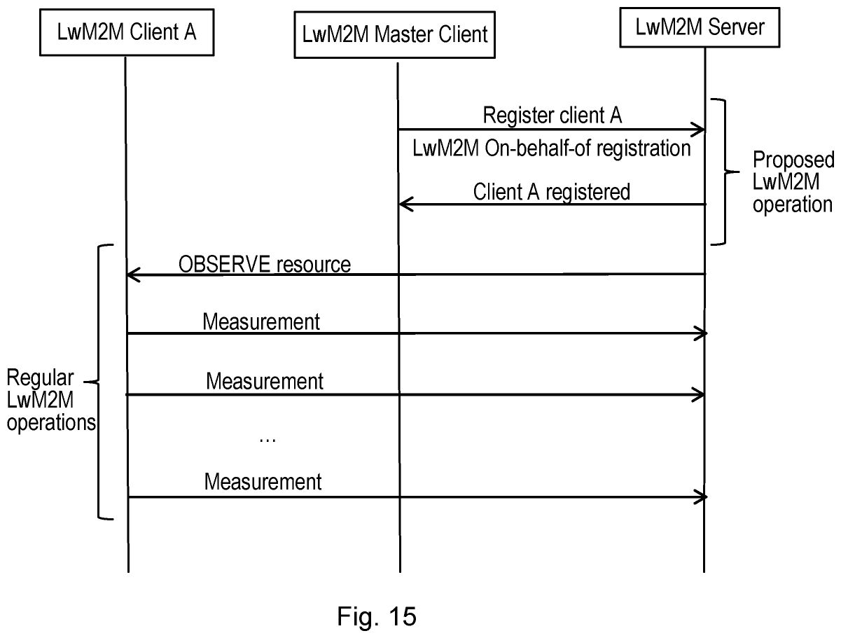

The methods and apparatus proposed in the present disclosure offer a solution for registration and bootstrapping of LwM2M client nodes that differs considerably from those currently available, as demonstrated in FIGS. 15 to 17.

FIG. 15 illustrates registration by a LwM2M master client node on behalf of a LwM2M client node according to examples of the present disclosure. It can be seen that the registration operation is performed by the LwM2M master client node on behalf of the LwM2M client A, using a LwM2M registration request message. Once registration is complete, all other LwM2M operations are carried out directly between LwM2M client and server, without going through the LwM2M Master Client node. This behaviour ensures that the LwM2M master client node can easily scale to handle registration on behalf of multiple LwM2M client nodes, and ensures that the LwM2M master client node does not represent a single point of failure during regular operations. It will be appreciated that in this context “directly” does not exclude the presence of routers or other transport network nodes on the path between the LwM2M client A and the LwM2M server.

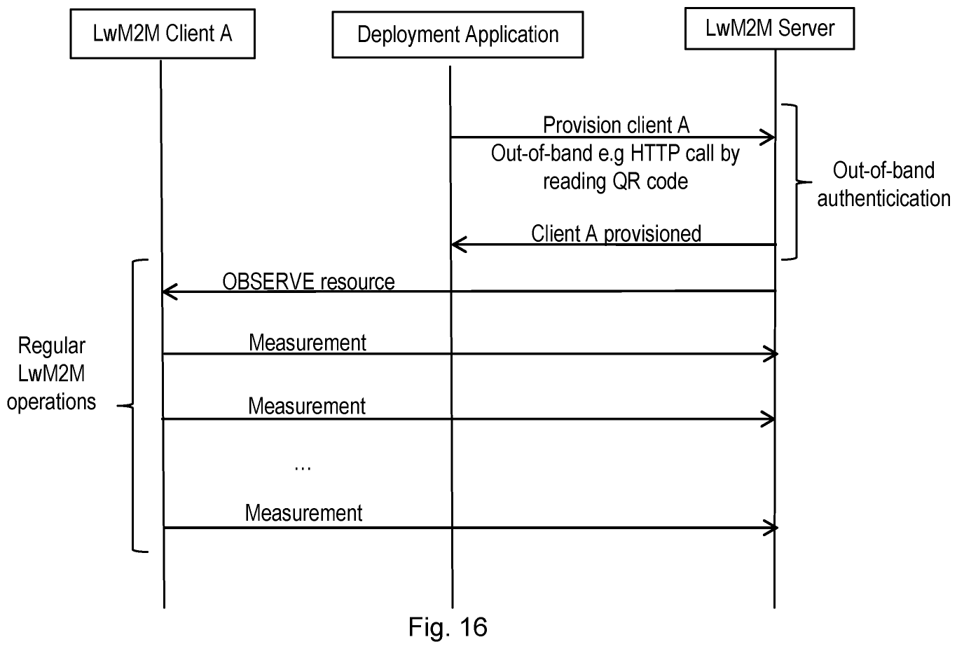

FIG. 16 illustrates provisioning of a LwM2M client node to a LwM2M server using a deployment application (such as a mobile application). As can be seen from FIG. 16, using a deployment application requires an out-of-band communication mechanism for provisioning between the LwM2M Server and the deployment application. This may for example be an HTTP interface, using proprietary HTTP Application programming Interface (API) commands, and is not native LwM2M.

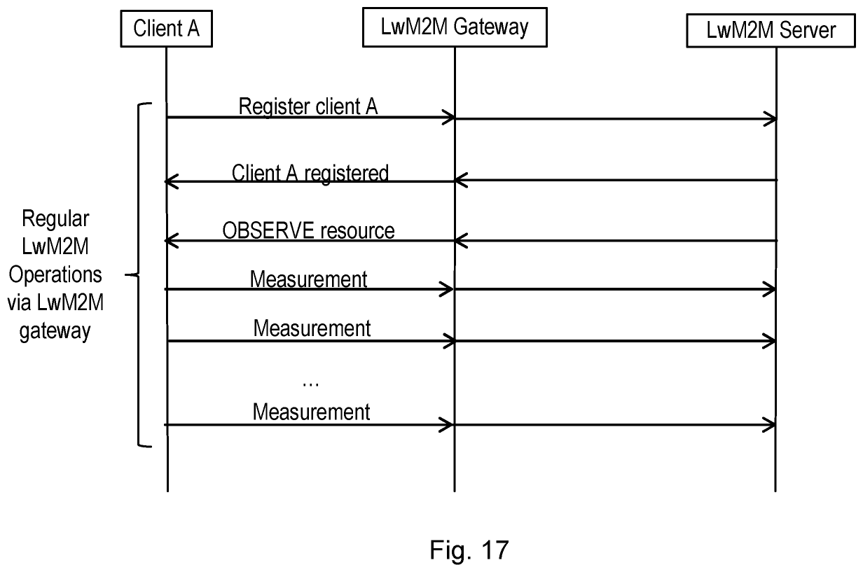

FIG. 17 illustrates how a LwM2M gateway can be used to provision a LwM2M client on the LwM2M server. As can be seen from FIG. 17, after registration, the LwM2M gateway remains on the network path between the LwM2M client A and the LwM2M server, meaning the gateway intercepts all other messages between the client and the management serve, and consequently all LwM2M operations need to go through LWM2M gateway. The LwM2M gateway thus represents a single point of failure for all clients using the gateway to register. In addition, there is a risk of the gateway being overloaded with regular LwM2M traffic.

Examples of the present disclosure propose a native LwM2M solution for on-behalf-of registration which eliminates the disadvantages of the methods demonstrated in FIGS. 16 and 17. For example, the LwM2M master client is used only for registration and/or bootstrapping, with all other LwM2M messages being exchanged directly between the LwM2M client and server. In addition, no additional or out-of-band interface, such as a web interface, is needed between LwM2M client and server, and the LwM2M master client does not represent a point of failure for all LwM2M operations

A very-constrained node, which is unable to perform the relatively complex LwM2M bootstrap and registration procedures, can thus be deployed in a network by having a LwM2M master client node perform those procedures on behalf of the very-constrained node. Examples of the present disclosure allow very-constrained devices to be supported without the need to use a full network gateway node. In addition, once the bootstrap and the registration processes are completed, the methods and apparatus of the present disclosure do not add overhead to regular LwM2M operations of the system, such as the sending of notifications.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. (canceled)

2. (canceled)

3. A method performed by a Lightweight Machine to Machine, LwM2M, master client node, the method comprising:
sending a request message to a LwM2M server, the request message requesting the LwM2M server to perform an operation with respect to a LwM2M client node; and
instructing the LwM2M server that, following completion of the operation, any subsequent messages relating to the LwM2M client node should be exchanged between the LwM2M client node and the LwM2M server.

4. The method as claimed in claim 3, wherein the LwM2M server comprises at least one of LwM2M bootstrapping server or a LwM2M management server, wherein the operation comprises at least one of a bootstrapping operation or a registration operation, and wherein the subsequent messages comprise at least one of subsequent bootstrapping messages or application messages.

5. The method as claimed in claim 3, wherein the request message comprises an identification of the LwM2M client node.

6. The method as claimed in claim 3, wherein the request message comprises an identification of the LwM2M master client node.

7. The method as claimed in claim 3, wherein instructing the LwM2M server that, following completion of the operation, any subsequent messages relating to the LwM2M client node should be exchanged between the LwM2M client node and the LwM2M server comprises including in the request message a LwM2M option corresponding to a master client operational mode of the LwM2M server.

8. The method as claimed in claim 7, wherein a master client operational mode of the LwM2M server comprises an operational mode according to which an operation relating to a LwM2M client node is performed on behalf of the LwM2M client node by a LwM2M master client node, and, following completion of the operation, any subsequent messages relating to the LwM2M client node are exchanged between the LwM2M server and the LwM2M client node.

9. The method as claimed in claim 3, further comprising:
sending to the LwM2M server an authorisation token, the authorisation token configured to certify that the LwM2M master client node is authorised to request the LwM2M server to perform the operation with respect to the LwM2M client node.

10. The method as claimed in claim 9, wherein sending to the LwM2M server an authorisation token comprises at least one of:
including the authorisation token in the request message; or
sending an authorisation message to the LwM2M server and including the authorisation token in the authorisation message.

11. The method as claimed in claim 9, wherein the authorisation token comprises at least one of:
a certificate issued by a Certification Authority; or
a web token.

12. The method as claimed in claim 3, further comprising:
informing at least one of:
the LwM2M client node; or
an operating authority;
of completion of the operation.

13. The method as claimed in claim 12, wherein the LwM2M server comprises a LwM2M bootstrap server, wherein the operation comprises a bootstrapping operation, wherein the method further comprises receiving from the LwM2M server configuration information for the LwM2M client node from the LwM2M bootstrap server, and wherein informing at least one of the LwM2M client node or an operating authority of completion of the operation comprises forwarding the received configuration information for the LwM2M client node to at least one of the LwM2M client node or the operating authority.

14. The method as claimed in claim 3, wherein the operation comprises a registration operation, and the LwM2M server comprises a LwM2M management server, and wherein the subsequent messages exchanged between the LwM2M client node and the LwM2M server following completion of the operation comprise reporting messages.

15. The method as claimed in claim 3, wherein the operation comprises a bootstrapping operation, and the LwM2M server comprises a LwM2M bootstrap server, the method further comprising:
sending a request message to a LwM2M management server, the request message requesting the LwM2M management server to perform a registration operation with respect to a LwM2M client node; and
instructing the LwM2M management server that, following completion of the registration operation, any application messages relating to the LwM2M client node should be exchanged between the LwM2M client node and the LwM2M management server.

16. A method performed by a Lightweight Machine to Machine, LwM2M, server, the method comprising:
receiving a request message from a LwM2M master client node, the request message requesting the LwM2M server to perform an operation with respect to a LwM2M client node;
receiving an instruction from the LwM2M master client node that, following completion of the operation, any subsequent messages relating to the LwM2M client node should be exchanged between the LwM2M client node and the LwM2M server;
performing the requested operation with respect to the LwM2M client node; and
after completion of the operation, exchanging any subsequent messages relating to the LwM2M client node with the LwM2M client node.

17. The method as claimed in claim 16, wherein the LwM2M server comprises at least one of LwM2M bootstrapping server or a LwM2M management server, wherein the operation comprises at least one of a bootstrapping operation or a registration operation, and wherein the subsequent messages comprise at least one of subsequent bootstrapping messages or application messages.

18. The method as claimed in claim 16, wherein the request message comprises an identification of the LwM2M client node.

19. The method as claimed in claim 16, wherein the request message comprises an identification of the master client node.

20. The method as claimed in claim 16, wherein receiving an instruction from the LwM2M master client node that, following completion of the operation, any subsequent messages relating to the LwM2M client node should be exchanged between the LwM2M client node and the LwM2M server comprises receiving in the request message a LwM2M option corresponding to a master client operational mode of the LwM2M server.

21. The method as claimed in claim 20, wherein a master client operational mode of the LwM2M server comprises an operational mode according to which an operation relating to a LwM2M client node is performed on behalf of the LwM2M client node by a LwM2M master client node, and any subsequent messages relating to the LwM2M client node and exchanged after completion of the operation are exchanged with the LwM2M client node.

22. The method as claimed in claim 16, further comprising:
receiving from the LwM2M master client node an authorisation token, the authorisation token configured to certify that the LwM2M master client node is authorised to request the LwM2M server to perform the operation with respect to the LwM2M client node; and
verifying, using the authorisation token, that the LwM2M master client node is authorised to request the operation with respect to the LwM2M client node.

23. The method as claimed in claim 22, wherein receiving from the LwM2M master client node an authorisation token comprises at least one of:
receiving the authorisation token in the request message; or
receiving an authorisation message from the LwM2M master client node, wherein the authorisation token is included in the authorisation message.

24. The method as claimed in claim 22, wherein the authorisation token comprises at least one of:
a certificate issued by a Certification Authority; or
a web token.

25. The method as claimed in claim 16, wherein the LwM2M server comprises a LwM2M bootstrap server and the operation comprises a bootstrapping operation, and wherein the method further comprises sending to the LwM2M master client node configuration information for the LwM2M client node to the LwM2M master client node.

26.-33. (canceled)

34. A Lightweight Machine to Machine, LwM2M, master client node (900) comprising processing circuitry configured to cause the LwM2M master client node to:
send a request message to a LwM2M server, the request message requesting the LwM2M server to perform an operation with respect to a LwM2M client node; and
instruct the LwM2M server that, following completion of the operation, any subsequent messages relating to the LwM2M client node should be exchanged between the LwM2M client node and the LwM2M server.

35. (canceled)

36. A Lightweight Machine to Machine, LwM2M, server comprising processing circuitry configured to cause the LwM2M server to:
receive a request message from a LwM2M master client node, the request message requesting the LwM2M server to perform an operation with respect to a LwM2M client node;
receive an instruction from the LwM2M master client node that, following completion of the operation, any subsequent messages relating to the LwM2M client node should be exchanged between the LwM2M client node and the LwM2M server;
perform the requested operation with respect to the LwM2M client node; and
after completion of the operation, exchange any subsequent messages relating to the LwM2M client node with the LwM2M client node.

37.-39. (canceled)
